(19) United States
(12) Patent Application Publication
(10) Pub. No.: US 2008/0247265 A1
(43) Pub. Date: Oct. 9, 2008

(54) Volumetric based chemical mixing system

(76) Inventor: Daniel H. Wilcox, Austin, TX (US)

Correspondence Address: Mr. Daniel H. Wilcox, 5808 Taylorcrest Drive, Austin, TX, 78749, US

(21) Appl. No.: 11/649,130

(22) Filed: Apr. 9, 2007

(51) Int. Cl. G01N 31/16; G01N 27/02; G05B 15/00

(52) U.S. Cl. 366/152.2; 366/132; 366/152.4; 422/75; 700/83

(57) ABSTRACT

The present invention provides an apparatus for the mixing or dilution of chemicals from one more sources that have been analyzed using laboratory analysis or an insitu-analyzer for concentration or molarity. The chemical is then transferred to a series of precisely calibrated vessels each of have a volume 10% of the next vessel. For example the main vessel may be 1 L in volume and the second vessel is 0.1 L in volume, the third is 0.01 L in volume and the fourth is 0.001 L in volume. The present system utilizes these two or more metered vessels which are connected to bulk chemical sources via intake lines. Each metered vessel contains an overflow tube, which drains any excess chemical by gravity flow from the metered vessel so as to adjust the chemical amount to a pre-calibrated desired level. As the chemicals exit the angle pipes, sensors located at the end of the overflow tube sense the chemical being discharged and trigger the feed pump and valve to shut off, whereby the excess chemicals will continue to drain out until the chemical levels reach the same level as the vent port of the pipe attached to the metered vessels. The excess chemicals are then drained into a recovery vessel which then can be transferred back to the bulk sources via a feed pump or pressure mechanism. The chemicals in the calibrated vessels are then dispensed by gravity lines to the mix tank vessel for mixing and subsequently delivered to a qualification vessel which may be verified using titration or online Ion Chromatography.

Specifications

| | |
|---|---|
| References Cited | [Referenced By] |

U.S. Patent Documents

| | | |
|---|---|---|
| 6,550,649 | April 2003 | Han, et al |
| 7,063,455 | June 2006 | Achkire, et al |
| 3807701 | April 1974 | Reid et al. |
| 3877682 | April 1975 | Moss |
| 5580168 | December 1996 | Alireza et al. |
| 5800056 | September 1998 | Suzuki et al. |
| 6572255 | June 2003 | Husher |
| 5924794 | July 1999 | O'Dougherty, et al. |

Foreign Patent Documents

| | | |
|---|---|---|
| 0136961 | April, 1985 | EP |
| 2081119 | February, 1982 | GB |

### FIELD OF THE INVENTION

The present invention is concerned with semiconductor device manufacturing, and is more particularly concerned with apparatus and methods for diluting a chemical used in connection with semiconductor device manufacturing. This device can be used in other high tech application s such as pharmaceutical or specialty chemical blending applications.

### BACKGROUND

Typical chemical dilution systems use a variety of methods to assure precise measurement of the chemical components that are blended to make up the final chemical solution. Some of these methods include mass based methods which use load cells to measure the weight of the components of chemicals to be mixed. Others use flow meters to measure flow of the components of chemicals to be mixed. In some cases the system uses mass-flow controllers which determine a combination of mass and flow to of the components of chemicals to be mixed. Finally some of these systems use conductivity to determine the concentration of the final mix of chemistry. All of these types of instruments have a certain amount of variation or inaccuracy of the output based on the electrical tolerances of the devices that do not meet some of the tight tolerances or specifications in certain high tech or pharmaceutical applications.

This invention uses precisely calibrated vessels that can be filled to an exact volume every time. This gives an extremely repeatable process that can not be varied by any inaccuracy or variation of instrumentation.

### SUMMARY OF THE INVENTION

This invention incorporates three main process stages in order to blend or dilute chemicals, a concentrate storage stage which is a storage and transfer process of the concentrated chemistry, a concentrate measuring stage which is a series of precisely calibrated vessels containing concentrated chemical that is used to measure and transfer the concentrated chemical needed for the chemical mixture, a dilution stage which is a precisely calibrated vessel that contains dilution water that is used to measure and transfer the water needed to dilute the chemical mixture.

The invention further includes an auto titration device coupled to the concentrate storage stage that measures the normality of the concentrate chemical. This can also be done by lab analysis prior to the concentrate chemistry being put online.

The invention further includes a Programmable Logic Controller (PLC) or similar device that is programmed to determine a dilution ratio for the final mixed chemical based on the exact calibrated volume of water as it will be mixed with a calculated number of vessel volumes or “shots” from the series of calibrated vessels in the concentrate measuring stage. The controller is further programmed to transfer the precisely calibrated volume of dilution water and concentrated chemicals to the mix vessel using gravity to achieve the dilution ratio to within the desired tolerance. As is understood by those who are skilled in the art, “chemistry” or “a chemistry” refers to any chemical substance, solution and/or mixture.

The invention includes a concentrated chemistry mixing stage which is made up of a series of precisely calibrated vessels that can be added to a chemical mix in predetermined combination s to achieve a precise mixture within a desired tolerance.

The invention includes a qualification stage which includes a storage tank, pumping device, and quality verification analyzer used to verify the final concentration of the mixture to the desired tolerance.

The apparatus and methods of the present invention are well suited to precisely provide a highly dilute chemistry (e.g., a surfactant or other chemical) to a semiconductor device processing apparatus (e.g., photo track or the like) or similar pharmaceutical devices. In addition, the inventive apparatus and methods can be provided cost effectively, and can be arranged to selectively operate so only concentrated chemistry is used without dilution.

Other features, operations, and benefits of the present invention will become more apparent from the detailed description of the invention, the appended claims and the accompanying drawings.

### BRIEF DESCRIPTION OF THE DRAWINGS

FIG. 1 is a high Process Flow diagram (PFD) of the invention showing the overall process sections of the system in block diagram format.

FIG. 2 is a Process and Instrumentation Diagram (P&ID) of the invention showing a complete overview of the components of the invention including all mechanical, electrical and control system components.

FIG. 3 is an isometric view of the concentrate chemical measuring and chemistry mixing enclosure cabinet.

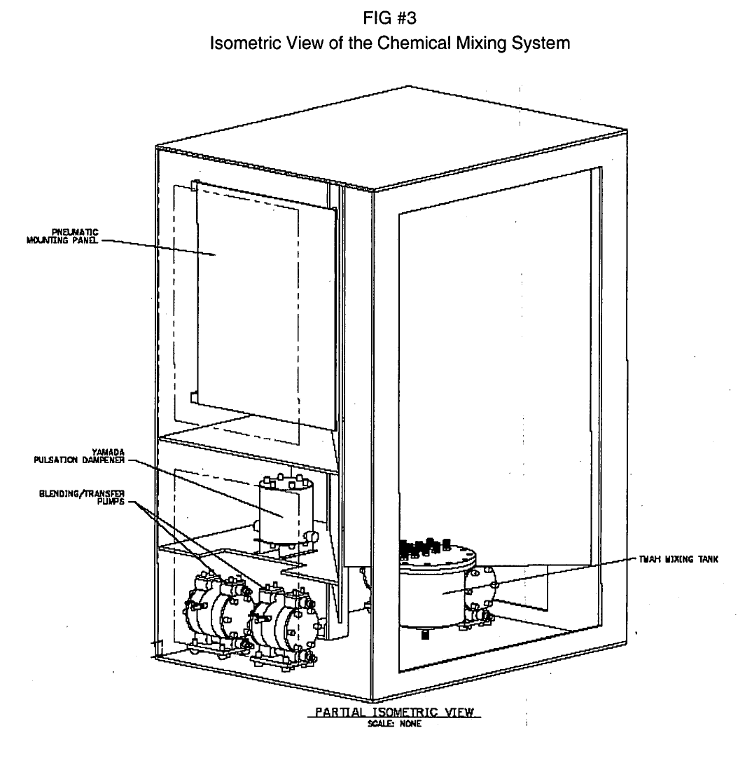

FIG. 4 is a plan view of the concentrate chemical measuring and chemistry mixing enclosure cabinet.

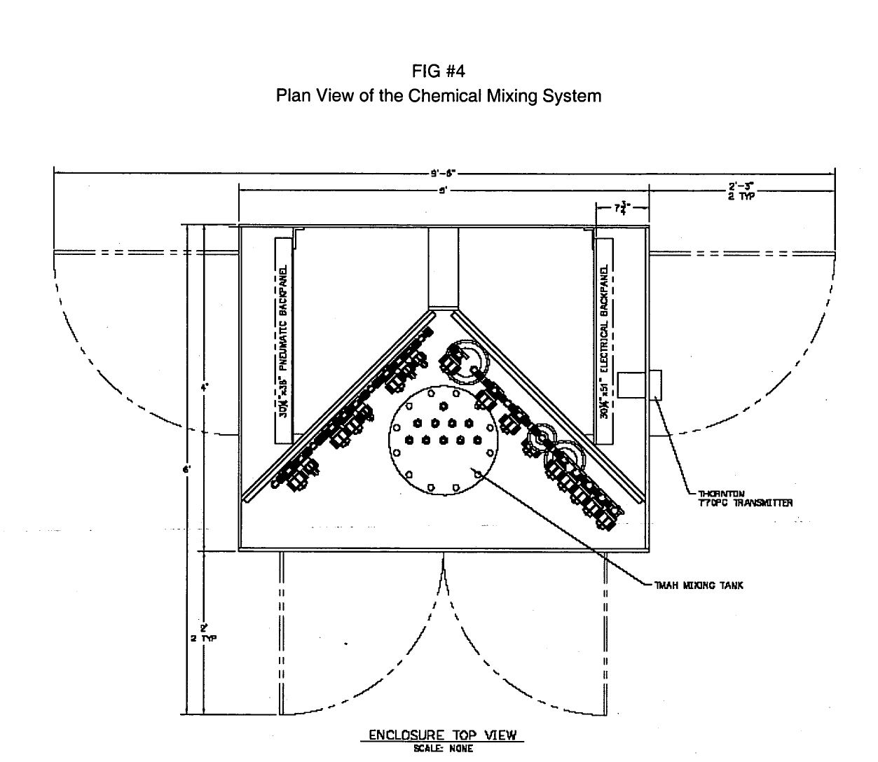

FIG. 5 is a front view of the concentrate chemical measuring and chemistry mixing enclosure cabinet.

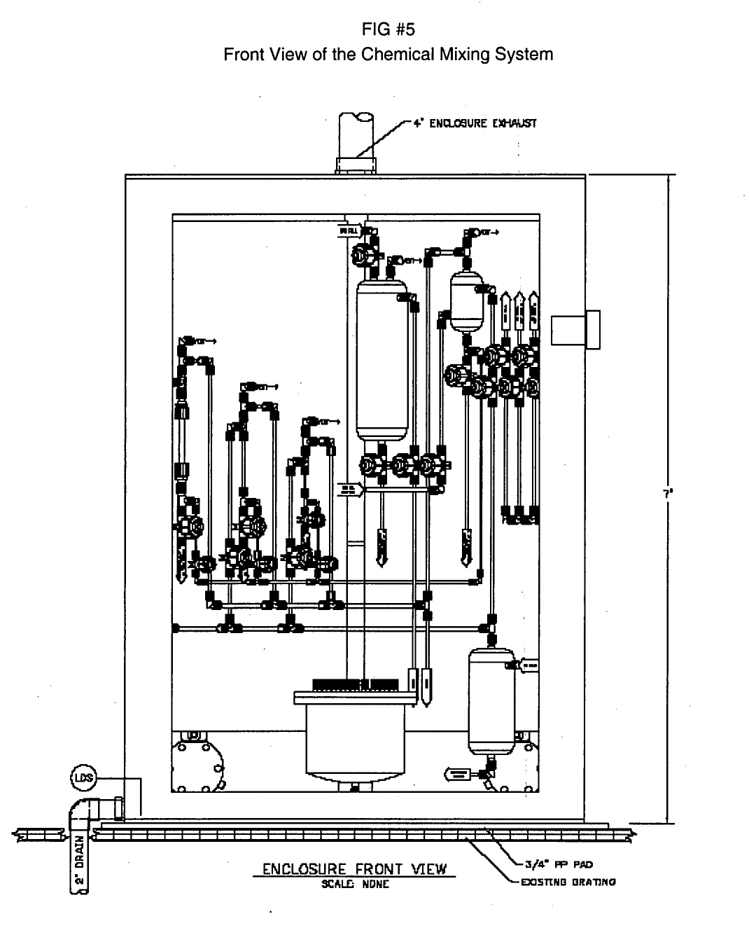

FIG. 6 is a detailed view of the concentrate chemical measuring and chemistry mixing panels.

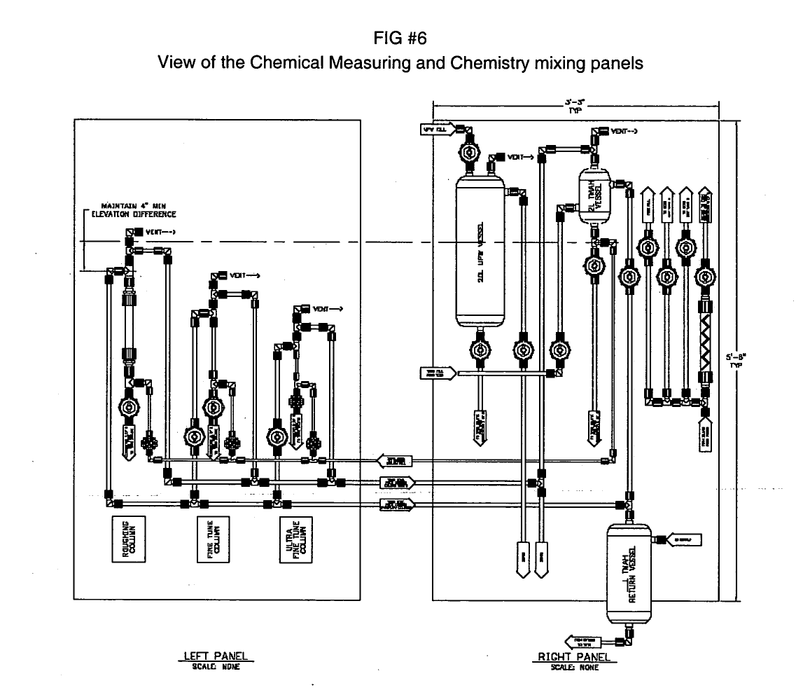

### DETAILED DESCRIPTION OF THE INVENTION

The present invention provides for a chemical dilution or mixing system that utilizes precisely calibrated fixed volume vessels to attain a final mixture within a tight tolerance.

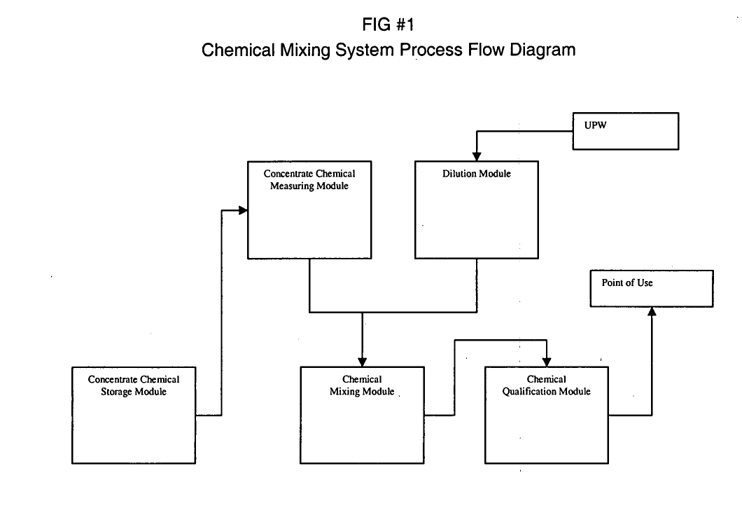

FIG. 1 is a Process Flow Diagram that shows the major components of the Chemical Mixing System. The major components include a Concentrate Chemical Storage Module, a Concentrate Chemical Measuring Module, a Dilution Module, a Chemical Mixing Module and a Chemical Qualification Module.

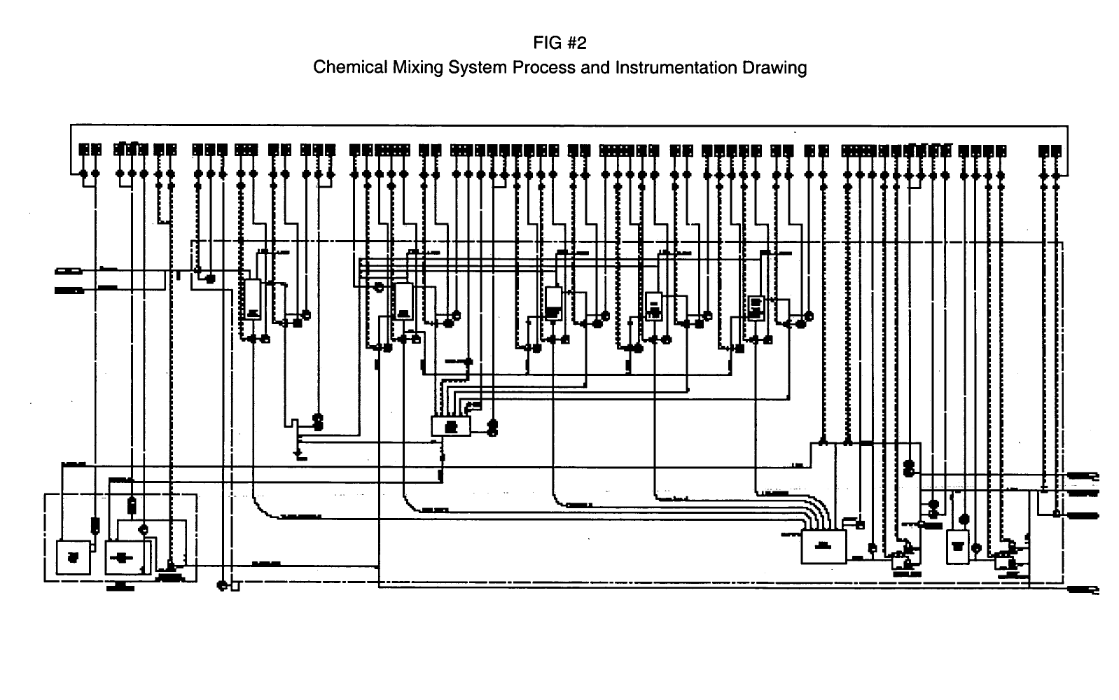

FIG. 2 is a process and Instrumentation diagram which shows the detailed components and instrumentation that makes up the chemical mixing system.

The Concentrate Chemical Storage in FIG. 2 consists of a bulk container (TC101) that is staged in a temperature controlled room for a minimum of 24 hours so as to stabilize the temperature of the concentrate chemical as measured using (TIT101C). The concentrate chemical is also re-circulated using pump (P101) and filtered using (F102) for 24 hours to reduce suspended particles.

The concentrate chemical is analyzed for concentration either with laboratory analysis or using an on-line titration analyzer (AIT101D). The concentration result is automatically sent to the PLC or entered manually into the control system using the operator interface system.

Once the concentration data is entered in the control system the Programmable Logic Controller (PLC) uses an algorithm to calculate the exact volume of concentrate chemical is needed along with the fixed volume of dilution water to result in the desired final concentration of mixed chemical.

The Dilution Module shown in FIG. 2 includes a precisely calibrated vessel (TT200) that is filled with Ultra Pure Water (UPW) by opening inlet valve (V201). The liquid level then overflows into the tube and a sensor (LSH2038) detects liquid in the overflow tube which shuts off the feed valve (V201). Next the overflow tube drain valve (V203) opens and empties the overflow tube of its liquid into a drain. This will always provide the same volume of dilution water.

The dilution vessel is manufactured to be very close to 20 liters, but the actual volume is measured using a graduated cylinder and recorded in the PLC as the fixed volume.

The Concentrate Chemical Measuring Module in FIG. 2 includes a series of precisely calibrated vessels. The Concentrate Chemical Vessel is manufactured to be very close to 2 liters, but the actual volume is measured using a graduated cylinder and recorded in the PLC as the fixed volume. The Roughing Chemical Vessel (TT400) is manufactured to be very close to 0.1 liters, but the actual volume is measured using a graduated cylinder and recorded in the PLC as the fixed volume. The Fine Tune Chemical Vessel (TT500) is manufactured to be very close to 0.02 liters, but the actual volume is measured using a graduated cylinder and recorded in the PLC as the fixed volume. The Ultra-Fine Tune Chemical Vessel is manufactured to be very close to 0.002 liters, but the actual volume is measured using a graduated cylinder and recorded in the PLC as the fixed volume.

This series of incrementally smaller chemical measuring vessels allows the ability to add small amounts of concentrated chemical as determined by the variation in concentrate chemical assay as measured by laboratory analysis or online titration analyzer. Multiple volumes or “shots” can be added from any of the chemical measuring vessels as determined by the PLC algorithm.

The Concentrate Chemical Vessel (TT300) is filled with concentrated chemical using pump (P101) and opening inlet valve (V301). The liquid level then overflows into the tube and a sensor (LSH3038) detects liquid in the overflow tube which shuts off the feed valve (V301). Next the overflow tube drain valve (V303) opens and empties the overflow tube of its liquid into a chemical recovery vessel (TR900). This will always provide the same volume of concentrated chemical.

The content of the Dilution Vessel (TT200) is emptied into the mix tank (TM700) by opening outlet valve (V202).

The content of the Concentrate Chemical Vessel (TT300) is emptied into the mix tank (TM700) by opening outlet valve (V302).

The Concentrate Chemical Measuring Vessel (TT300) is then filled again with concentrated chemical using pump (P101) and opening inlet valve (V301). The liquid level then overflows into the tube and a sensor (LSH3038) detects liquid in the overflow tube which shuts off the feed valve (V301). Next the overflow tube drain valve (V303) opens and empties the overflow tube of its liquid into a chemical recovery vessel (TR900).

The Chemical Measuring Vessel (TT300) is mounted at a higher elevation than the Roughing Column (TT400), Fine Tune Column (TT500), and Ultrafine Column (TT600). This allows the Chemical Measuring Vessel (TT300) to be used as a low pressure fill source for the other vessels TT400, TT500, & TT600.

The Chemical Measuring Vessel (TT300) is mounted is then used to fill the Roughing Column (TT400), Fine Tune Column (TT500), and Ultrafine Column (TT600) any number of times based on the algorithm in the PLC that calculates the number of shots needed of each of the various Chemical Measuring vessels to reach the desired endpoint of the final mixed chemical.

Example: The concentrate chemical is 25.08% and the desired final endpoint concentration is 2.38±0.005%. 20 liters of UPW is emptied from the dilution vessel (TT200) into the mix vessel (TM700) and combined with 2 liters of concentrate chemical from the Chemical Measuring Vessel (TT300). In order to reach the desired final endpoint concentration is 2.38 ±0.005%, the PLC would add 4 volumes or “shots” from the Fine Tune Chemical Vessel (TT500) and 7 volumes or “shots” from the Ultra-Fine Tune Chemical Vessel (TT600).

Once the final mix is in the Mix Vessel (TM700) it is re-circulated using the mix module pumps (P702 or P703) through static mixer (SM701), through conductivity sensor (AIT7520) and back to the Mix Vessel (TM701). Level switches (LSH748A & LSL749A) are used on the Mix Vessel (TM700) to prevent tank overflow or low level pump starvation. The conductivity sensor (AIT7520) is used to determine that the solution has reached homogeneous mix equilibrium and is then ready to transfer to the qualification tank (TQ800).

Once in the Qualification tank (T0800) the mixed chemical is re-circulated using the Qualification module pumps (P801 or P802). Several batches from the Chemical Mix Module will ten fill the Qualification module prior to sample and analysis by the online titration analyzer. A sample line from the qualification tank (TQ800) to the auto-titration instrument enables online qualification of the Qualification Tank (TQ800). It may take several minutes for the auto-titration analyzer to sample and analyze, therefore the qualification tank may contain a composite mix of several batches from the mix module.

When the Point of Use requires a fill, the Chemical Mix Module would stop mixing batches and stop transferring batches to the Qualification module. This would allow the auto titrator to sample and analyze the current composite mix in the Qualification tank (TQ800) and verify the quality to transfer to the Point of Use.

Once the transfer to the Point of Use is complete the Chemical Mix Module can begin making batches and filling the Qualification module.

If the Auto titrator determines that the composite mixture is out of tolerance, the Qualification tank can be pumped to a rework tank or tote for future disposition.

A backup tote of dilute material (TD104) is in standby mode to deliver to the Point of Use in case of a out of tolerance mix, or if any system failure in the Chemical mixing system occurs.

The invention claimed is:

1. A bulk concentrate chemistry stage comprising of one or more storage vessels adapted to store a concentrated chemistries; a low sheer pump such as a bellows type pump to transfer each of the concentrated chemicals to a series of fixed volume vessels of which the concentrated chemistry has precisely determined concentration using laboratory analysis or using an online auto titrator or online Ion Chromatography analyzer.

2. A control system consisting of a programmable logic controller (PLC) or similar control processor is used to accept inputs from analyzers and/or operator interface software as well as complete algorithms, computations, to control valves, pumps, and other mechanical components.

3. An operator interface connected to the control system in claim 2 is capable of accepting input from operations technicians as well as to display system functions and status to operations technicians and transfer data to and from the system control processor.

4. A concentrated chemistry measuring stage comprising of two or more precisely calibrated vessels being the primary vessel, secondary vessel, tertiary vessel, a recovery vessel, a mix vessel and a qualification vessel.

5. The primary vessel described in claim 4 is designated as the roughing vessel and for this example may be 2 L in volume and is located at an elevation higher than the secondary and tertiary and all subsequent calibrated vessels so it can be used as a low pressure source to supply concentrated chemical to the smaller calibrated vessels using gravity pressure.

6. The primary vessel described in claim 5 is manufactured with an overflow tube at a precise location in the vessel so as to create a fixed volume of 2 L in the vessel when filled to the overflow tube level.

7. A sensor located in the overflow tube of the primary vessel in claim 5 senses when the vessel overflow height has been reached and therefore shuts off the chemical feed from the bulk concentrate chemistry stage to the primary vessel.

8. The level in the primary vessel in claim 5 will then equalize at the level of the overflow tube which has been pre-calibrated using graduated a cylinder.

9. The overflowed chemical in the primary vessel in claim 5 is then captured by gravity feed in a recovery vessel which then can be transferred back to the bulk concentrate chemical container using a pump or by using an external pressure source. The primary vessel described in claim 5 is located at a higher elevation that the mix vessel whereas gravity can be used to transfer the contents of the primary vessel into the mix vessel.

10. The primary vessel described in claim 5 is located at a higher elevation that the secondary vessel whereas gravity can be used to transfer the contents of the primary vessel into the secondary vessel. This allows a controlled transfer into the secondary vessel using the minimal gravity pressure differential so as not to overfill the secondary vessel and as an energy savings consideration.

11. The primary vessel described in claim 5 is located at a higher elevation that the tertiary vessel whereas gravity can be used to transfer the contents of the primary vessel into the tertiary vessel. This allows a controlled transfer into the tertiary vessel using the minimal gravity pressure differential so as not to overfill the tertiary vessel and as an energy savings consideration.

12. The secondary vessel described in claim 5 is designated as the fine tune vessel and for this example may be 0.2 L in volume or 1/10^{th} the volume of the primary vessel.

13. The secondary vessel described in claim 12 is manufactured with an overflow tube at a precise location in the vessel so as to create a fixed volume of 0.2 L in the vessel when filled to the overflow tube level.

14. A sensor located in the overflow tube of the secondary vessel described in claim 12 senses when the vessel overflow height has been reached and therefore shuts off the chemical feed from the primary vessel to the secondary vessel.

15. The level in the secondary vessel in claim 12 will then equalize at the level of the overflow tube which has been pre-calibrated using graduated a cylinder.

16. The overflowed chemical from the secondary vessel described in claim 12 is then captured by gravity feed in a recovery vessel which then can be transferred back to the bulk concentrate chemical container using a pump or by using an external pressure source.

17. The tertiary vessel described in claim 5 is designated as the ultra fine tune vessel and for this example may be 0.02 L in volume or 1/100^{th} the volume of the primary vessel.

18. Additional chemical vessels described in claim 5 can be added to meet a tighter tolerance of the final mix requirement, but we will use three stages as the example at hand.

19. A recovery vessel as described in claim 5 is designated to capture excess overflow of concentrate chemical from the primary, secondary and tertiary so as to enable recovery of that excess chemical back to the concentrate stage.

20. A dilution stage described in claim 5 may be used for chemical dilution process using ultra pure water (UPW) that is fed into a precisely calibrated vessel that is larger than the main concentrated chemical vessel by the factor of the dilution ratio.

21. For example if the dilution ratio of the dilution stage in claim 20 is 10:1 then the dilution vessel in claim 22 may be 20 L and the concentrated chemical vessel would be 2 L.

22. The dilution stage vessel described in claim 20 is manufactured with an overflow tube at a precise location in the vessel so as to create a fixed volume of 20 L in the vessel when filled to the overflow tube level.

23. A sensor located in the overflow tube of the dilution vessel in claim 20 senses when the vessel overflow height has been reached and therefore shuts off the UPW feed to the dilution vessel.

24. The level in the dilution vessel in claim 20 will then equalize at the level of the overflow tube which has been pre-calibrated using graduated a cylinder.

25. The overflowed UPW from the dilution vessel in claim 20 is then captured by gravity drain.

26. The dilution vessel described in claim 20 is located at a higher elevation that the mix vessel whereas gravity can be used to transfer the contents of the dilution vessel into the mix vessel.

27. The dilution vessel in claim 20 wherein the controller is programmed to open the valve connected to the mix vessel and empty the entire calibrated content into the mix vessel thus having an exact volume of dilution water in the mix vessel.

28. The mix vessel as described in claim 5 is designated to accept dilution water from the calibrated dilution stage and concentrated chemical from the various calibrated concentrate chemical vessels, to gain a final endpoint chemical mix that is within the desired tolerance.

29. The qualification vessel as described in claim 5 is designated to accept a series of mixed batches of the diluted chemical.

30. An online analyzer such as an on-line titration analyzer or on-line ion-chromatography analyzer used to determine the contents of the qualification tank in claim 29 meets or exceeds the desired concentration tolerance.

31. The primary vessel in claim 5 wherein the controller is programmed to open the valve connected to the mix vessel and empty the entire calibrated content into the mix vessel thus having an exact volume of dilution water in the mix vessel.

32. The primary vessel in claim 5 wherein the controller is programmed to open the valve connected to the secondary vessel and fills the entire calibrated content of the secondary vessel thus having an exact volume of dilution water in the mix vessel.

33. The volume of chemical needed to create and end mix or dilution is determined by the lab analysis or online analyzer of the concentrate stage in claim 1.

34. The known precisely calibrated fixed volume of dilution water (UPW) in claim 20 is emptied into the mix vessel in claim 28 then the known precisely calibrated fixed volume of the primary vessel in claim 5 is emptied into the mix vessel in claim 30.

35. Then using an algorithm in the control system described in claim 2 multiples combinations of the secondary and tertiary calibrated concentrate vessels in claim 6 are emptied into the mix vessel to attain the final concentration within the desired tolerance.

36. The mix tank described in claim 28 is constantly re-circulated through a static mixer and filtered to remove particles.

37. The conductivity is measured in the mix tank recirculation described in claim 28 to determine when the mix has attained a homogeneous endpoint then it is transferred to the qualification tank.

38. The qualification tank described in claim 31 is then used to determine if the series of completed batches is within the desired tolerance by using an on-line titration unit or on-line ion chromatography analyzer.
